(19) United States
(12) Patent Application Publication
(10) Pub. No.: US 2007/0179852 A1
(43) Pub. Date: Aug. 2, 2007

(54) Media distribution systems

(75) Inventors: Glenn Martin, Atlanta, GA (US); Les Ottolenghi, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Intent Media Works Holding, LLC

(21) Appl. No.: 11/601,532

(22) Filed: Nov. 17, 2006

Related U.S. Application Data
(60) Provisional application No. 60/737,628, filed on Nov. 17, 2005.

(51) Int. Cl. G07G 1/14

(52) U.S. Cl. 705/14

(57) ABSTRACT

A media distribution computer system, in which the computer system is adapted for facilitating the communication (e.g., streaming) of advertisements, such as video advertisements, to a user in conjunction with the delivery of a media file to the user (such as a video or music file). The system may be configured to determine which advertisements to download to the user based, for example, on: (A) the time that the user requests a download or playback of the premium media content, and/or (B) the source of the request to download the premium media content. In various embodiments, the specific business rules may be attached to the media content files. These rules may be used to regulate the use of the files and/or to coordinate the delivery of advertisements to the user in conjunction with the playback of the files.

### CROSS-REFERENCE TO RELATED APPLICATIONS

This application claims the benefit of U.S. Provisional Patent Application Ser. No. 60/737,628, filed Nov. 17, 2005, the contents of which are incorporated herein by reference in their entirety.

### BACKGROUND OF THE INVENTION

The onset of Internet technology has made it possible for users of computing devices connected to the Internet to access vast and ever-increasing sources of media. However, despite the wide availability and volume of such information, the means of acquiring such information legally, or more importantly, the ability to make this information commercially rewarding to the content creators and electronic distributors remains elusive. As an example, Napster, one of the original file sharing companies, was shut down by the courts for allowing large groups of users to illegally trade media files.

Commercially available programs designed for retrieving and sharing files may be referred to as Peer-to-Peer (or “P2P”) Software. Current examples of such software include Kazaa™ and Limewire™. Various types of P2P Software allow users to exchange and play media files between their respective computing devices without the need to access a centralized server or service. This may lower the cost of distributing the files because the computer resources needed to support the network are provided by (and shared between) the various users of the network. In particular, in various P2P networks, each individual computer within the network stores files and transports files via its own network connection. This serves to distribute the cost of this activity across the various users of the network.

### SUMMARY OF VARIOUS EMBODIMENTS OF THE INVENTION

A media distribution computer system according to a particular embodiment of the invention is adapted for: (A) in response to receiving a request from a user for a first particular file during a first period of time, facilitating the communication of a first advertisement to the user, via an electronic device associated with the user, in conjunction with a transfer of the first particular file to the electronic device; (B) in response to receiving a request from the user for the first particular file during a second period of time, facilitating the communication of a second advertisement to the user, via the electronic device, in conjunction with a transfer of the first particular file to the electronic device; (C) in response to receiving a request from the user for a second particular file during the first period of time, facilitating the communication of a third advertisement to the user, via the electronic device, in conjunction with a transfer of the second particular file to the electronic device; and (D) in response to receiving a request from the user for the second particular file during the second period of time, facilitating the communication of a fourth advertisement to the user, via the electronic device, in conjunction with a transfer of the second particular file to the electronic device.

A computer system for facilitating the display of media files according to various embodiments of the invention is adapted for: (A) in response to receiving a request from a user to play a first particular media file during a first period of time, facilitating the communication of a first advertisement to the user via an electronic device associated with the user; (B) in response to receiving a request from the user to play the first particular file during a second period of time, facilitating the communication of a second advertisement to the user via the electronic device; (C) in response to receiving a request from a user to play a second particular media file during the first period of time, facilitating the communication of a third advertisement to the user via the electronic device; and (D) in response to receiving a request from the user to play the second particular file during the second period of time, facilitating the communication of a fourth advertisement to the user via the electronic device.

A media distribution computer system according to particular embodiments of the invention is adapted for: (A) in response to receiving a request from a user, via a first distribution source, for a first particular file, facilitating the communication of a first advertisement to the user, via an electronic device associated with the user, in conjunction with a transfer of the first particular file to the electronic device; (B) in response to receiving a request from the user, via a second distribution source, for the first particular file, facilitating the communication of a second advertisement to the user, via the electronic device, in conjunction with a transfer of the first particular file to the electronic device; (C) in response to receiving a request from the user, via the first distribution source, for a second particular file, facilitating the communication of a third advertisement to the user, via the electronic device, in conjunction with a transfer of the second particular file to the electronic device; and (D) in response to receiving a request from the user, via the second distribution source, for the second particular file, facilitating the communication of a fourth advertisement to the user, via the electronic device, in conjunction with a transfer of the second particular file to the electronic device.

A media distribution computer system according to various embodiments of the invention is adapted for: (A) in response to receiving a request from a user, made via a first distribution source during a first time period, for a first particular file, facilitating the communication of a first advertisement to the user, via an electronic device associated with the user, in conjunction with a transfer of the first particular file to the electronic device; (B) in response to receiving a request from the user, made via a second distribution source during the first time period, for the first particular file, facilitating the communication of a second advertisement to the user, via the electronic device, in conjunction with a transfer of the first particular file to the electronic device; (C) in response to receiving a request from the user, made via the first distribution source during a second time period, for the first particular file, facilitating the communication of a third advertisement to the user, via the electronic device, in conjunction with a transfer of the first particular file to the electronic device; and (D) in response to receiving a request from the user, made via the second distribution source during the second time period, for the first particular file, facilitating the communication of a fourth advertisement to the user, via the electronic device, in conjunction with a transfer of the first particular file to the electronic device.

A method, according to particular embodiments of the invention, of distributing a media file to a user comprises the steps of: (A) making a media file available to the user for download to a remote device; (B) receiving a request from the user to download the media file; and (C) in response to receiving the request, transmitting, to an electronic device associated with the user: (1) an advertisement, (2) a copy of the media file, and (3) file security software that is adapted to modify the user's access to the media file in response to the advertisement being played on the electronic device.

A method, according to various embodiments of the invention, of distributing a media file to a user comprises the steps of: (A) defining a set of advertisement distribution rules specifying that: (1) a first particular advertisement will be attached to the media file if the media file is downloaded during a first particular period of time; and (2) a second particular advertisement will be attached to the media file if the media file is downloaded during a second particular period of time; (B) making the media file available to the user for download to a remote device; (C) receiving a request from the user to download the media file; (D) determining whether the request was received during the first particular period of time; and (E) in response to determining that the request was received during the first particular period of time, transmitting, to an electronic device associated with the user: (1) a copy of the first particular advertisement, (2) a copy of the media file, and (3) file security software that is adapted to modify the user's access to the media file in response to the first particular advertisement being played on the electronic device; (F) in response to determining that the request was received during the second particular period of time, transmitting, to an electronic device associated with the user: (1) a copy of the second particular advertisement, (2) a copy of the media file, and (3) file security software that is adapted to modify the user's access to the media file in response to the second particular advertisement being played on the electronic device.

### BRIEF DESCRIPTION OF THE DRAWINGS

In the description below, reference will now be made to the accompanying drawings, which are not necessarily drawn to scale, and wherein:

FIG. 1 is a schematic diagram of a media distribution system according to a particular embodiment of the invention.

FIG. 2 depicts an exemplary media license authentication process according to a particular embodiment of the invention.

FIGS. 3 and 4 show examples of screens that may be displayed to a user while a media distribution system according to various embodiments of the present invention is acquiring a license from its licensing server.

FIGS. 5 and 6 show examples of an advertisement (e.g., a video advertisement) that is displayed before a user is permitted to play a particular media file.

FIG. 7 is an example of a “license issued” screen that is displayed after the advertisement of FIGS. 5 and 6 has been displayed to the user.

FIG. 8 is an example of a media playback screen during the playback of a particular media file.

FIG. 9 is an example of a report generated by the media distribution system.

### DETAILED DESCRIPTION OF VARIOUS EMBODIMENTS OF THE INVENTION

The present invention will now be described with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements.

Overview

Various embodiments of the present invention relate to systems that are configured to perform batch processing of analog and/or digital content (e.g., media files) so that the content may be shared across multiple networks and so that a business model, one or more advertisements, or a purchase may be tied directly to the content using DRM or other technology—preferably on a dynamic basis. In various embodiments, the system is adapted to record, track, and report the usage of this content and its association with payment and/or advertisements so that commercial payments can be made that correspond to the consumption/usage of each individual file or other content.

A media distribution system according to various embodiments of the present invention allows the rights holder of a media file to monetize his rights on digital networks by using a combination of: (1) Digital Rights Management (DRM) technology; (2) Dynamic Ad serving technology; and/or (3) behavioral targeting technology, to sell and/or dynamically serve advertisements directly relatable to the content (e.g., media files) being consumed regardless of the type of environment or digital network in which the file is to be used. In addition, in various embodiments, the system adds the necessary tags and metadata to media files to be exchanged on the network so that each file's usage rights and consumption activity can be captured and reported in a manner that allows the rights holder to receive payments from the consumer and/or the advertiser based on the specific activity surrounding that particular media file on a given network.

In various embodiments, all (or substantially all) media files to be exchanged through the system are processed through an encoder that: (1) processes files in bulk and attaches metadata and/or tags to the files; and/or (2) creates scripts and/or html pages that allow the system to transport, share, track, and report on the media files.

In particular embodiments of the invention, media files to be exchanged via the system are associated with a unique identifier that is then associated with a set of scripts and data that are communicated to various centralized services including:
1. A Licensing Service (e.g., EZDRM, BuyDRM, Synccast);
2. An Ad Serving Service (e.g., double click, AlmondNet, Tacoda);
3. A Payment Gateway (e.g., paypal, authorize.net, Javien); and/or
4. A Web Site Tracking Service (e.g., Web Trends).

The system may then consolidate data from one or more of these four services into a centralized database (e.g., the Palladia Platform™). This data may then be related through a series of tables and/or loading utilities to produce an organized view of the activity surrounding each particular file.

Overview of Selected System Components

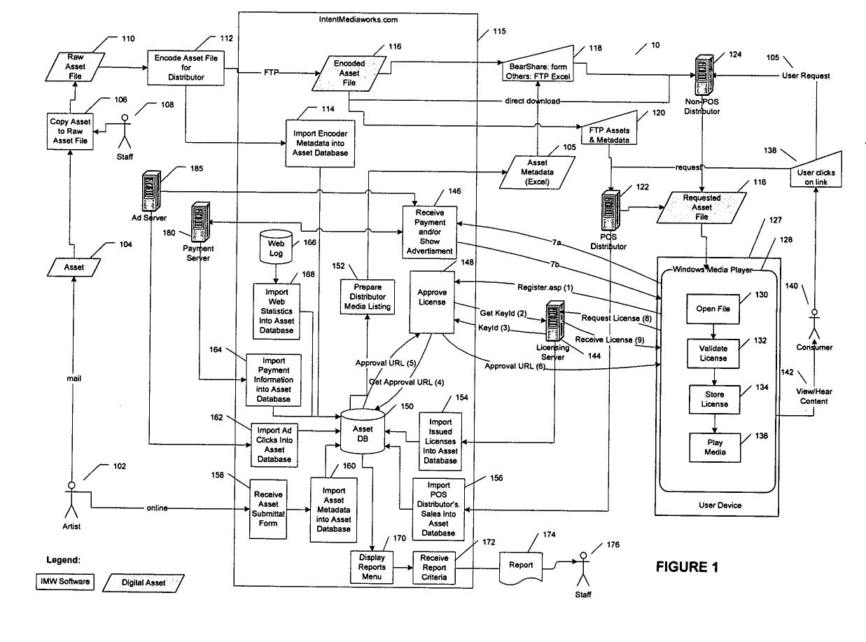

The structure and operational flow of an exemplary media distribution system 10 according to a particular embodiment of the invention is shown in FIG. 1. As may be understood from this figure, in this embodiment, the media distribution system 10 comprises a media distribution coordination system 115 (e.g., www.Intentmediaworks.com), a payment server 180, an advertisement server 185, a licensing server (e.g., a DRM Server) 144, at least one non-POS Distributor Server 124, at least one POS Distributor Server 122, and at least one user device 127 (e.g., a computer, cell phone, or portable media player). In various embodiments of the invention, the media distribution coordination system 115 is connected to communicate with one or more (and preferably all) of the other system components listed above via an appropriate network (e.g., a global communications network, such as the Internet). Also, in various embodiments of the invention, some or all of the various system components are connected to communicate with each other (e.g., via the Internet or other suitable network connection).

In certain embodiments of the invention, the advertising server 185 may be adapted to implement an ad serving service such as double click, AlmondNet, Tacoda, or any other suitable ad serving service for serving (e.g., streaming or downloading) ads to users to view in conjunction with playing a media file. Similarly, in particular embodiments, the payment server 180 may be adapted to provide a payment gateway such as PayPal, authorize.net, Javien, or any other suitable payment Gateway. This payment gateway may be adapted to facilitate the payment by a user for one or more media files accessed via the media distribution system 10.

Furthermore, in various embodiments, the media distribution system's Licensing Server 144 is associated with a licensing service such as EZDRM, BuyDRM, Synccast, or any other suitable licensing service that is configured for controlling the rights to access media files that are accessed via the media distribution system 10. An exemplary interaction of these various components, as implemented within a system according to the particular embodiment of the invention shown in FIG. 1, is provided below.

Overview of Exemplary System Flow

As may be understood from FIG. 1, in various embodiments, a process of preparing a file for use within the media distribution system 10 begins when an artist (or other content owner) 102 provides an asset 104 (e.g., a media asset, such as a song, video, or computer program) for distribution by the media distribution system 10. Next, at Step 106, the asset 104 is copied to a raw asset file 110. The system then proceeds to Step 112, where it encodes the raw asset file 110 for a particular distributor. As part of this step, an encoder is used to encode the raw asset file 110 with appropriate tags and metadata (which may, for example, be customized according to the distributor who will be distributing the resulting encoded asset file 116). These tags and metadata preferably dictate the rules (such as any of those described herein) according to which the asset file may be used. For example, the tags and metadata may specify the number of times that the asset file may be played and/or copied, and/or the rules according to which advertisements are to be played in conjunction with the playback of the asset file [e.g., whether an advertisement must be shown to the user each time that the user plays the asset file, or only upon (e.g., immediately before) the first playback of the asset file]. The asset's asset metadata may also be embedded into the “tags” of the asset file and then later placed in collateral surrounding the asset file upon playback of the asset file.

After the asset file has been encoded, at Step 114, the encoder metadata is imported into an asset database 150 associated with the media distribution coordination system 115. In addition, the encoded asset file 116 is transferred (e.g., via FTP or direct download) to: (1) one or more non-point-of-sale (non-POS) Distributor servers 124 that are associated with one or more non-POS distributors (e.g., a peer-to-peer file sharing web site, such as BearShare.com); and/or (2) one or more POS Distributor servers 122 that are associated with one or more point of sale (POS) distributors, such as iTunes.com. The POS and/or non-POS distributors associated with the POS and Non-POS Distributor Servers 122, 124 then make the asset file available for download from their respective web sites.

Turning to a specific example of a download from a Non-POS distributor server 124, a user may visit the Non-POS Distributor's web site and then request a specific asset file for download from the Non-POS Distributor's web site (e.g., by clicking on an icon associated with the desired asset file). In response to receiving this request, the Non-POS distributor server 124 downloads the requested asset file 116 to an electronic user device 127 associated with the user (e.g., the user's computer or cell phone) for playback by a suitable media player, such as Windows Media Player.

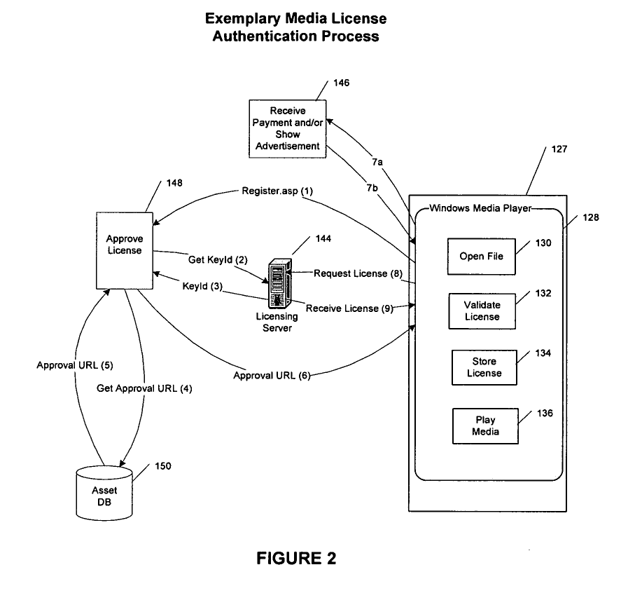

After the file has been downloaded to the user's electronic device 127, the user uses a media player 126 to open the file at Step 130. In various embodiments, this begins a media license authentication process, an example of which is depicted in FIGS. 1 and 2.

Turning to FIGS. 1 and 2, at Step (1) the media license authentication process begins when the user's media player 128 requests a license from the media distribution coordination system 115. If the license is approved, at Step (2), the media distribution coordination system 115 requests a key ID (which is preferably a unique key ID) from the Licensing Server 144. At Step (3), the Licensing Server 144 returns an appropriate key ID to the media distribution coordination system 115. Next, at Steps (4) and (5), the media distribution coordination system 115 obtains an approval URL from the system's asset database 150. The media distribution coordination system 115 then transmits the approval URL to the user's media player 128 at Step (6).

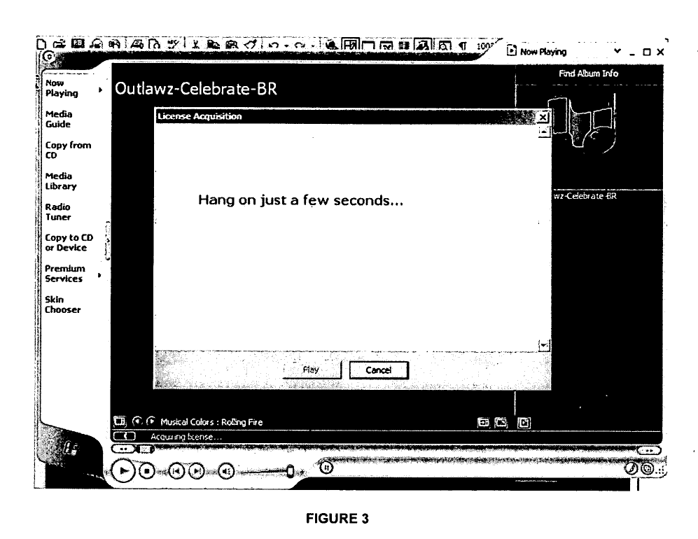

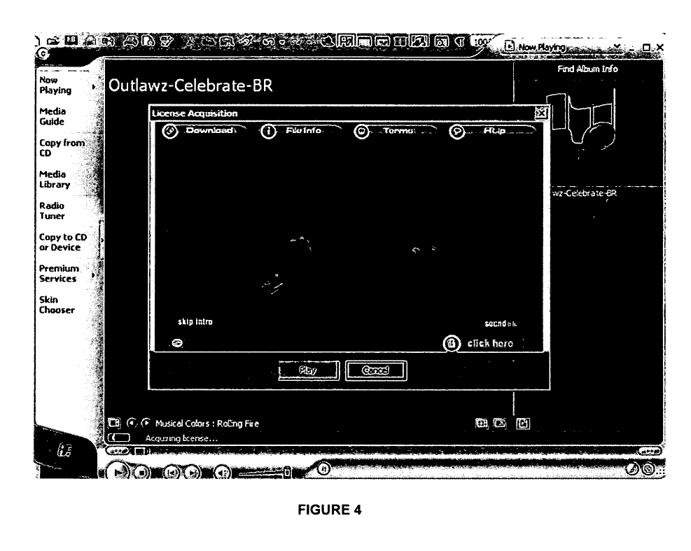

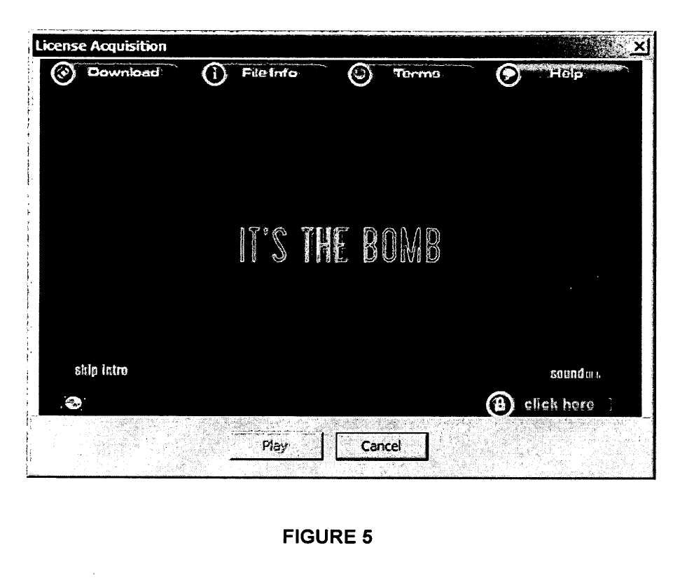

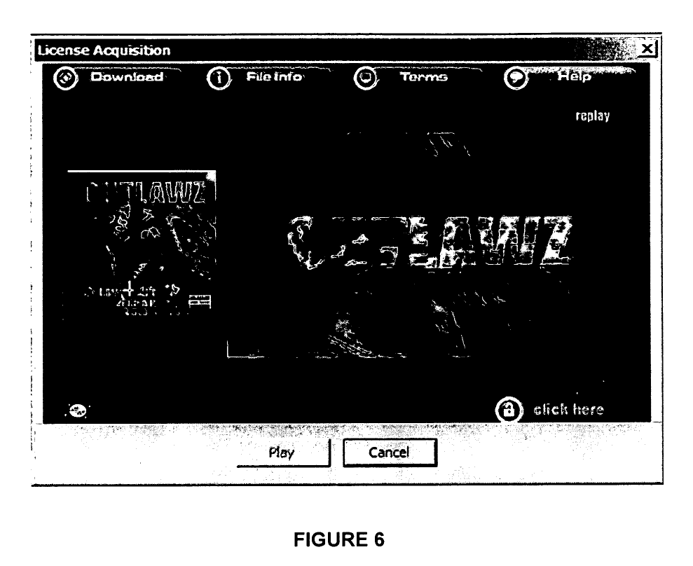

Next, the user's media player 128 uses the approval URL to access a web page that is customized for the asset file requested by the user. An example of such a web page is shown in FIG. 3. Next, at Step 146, the media distribution coordination system 10 determines, based on the metadata associated with the asset file, whether, for example: (1) an advertisement is to be shown in conjunction with the playback of the asset file (in which case, there is typically no charge to the user for downloading and playing the asset file); or (2) the user is to pay for downloading and playing the asset file. Next, depending on the metadata associated with the asset file, the media distribution coordination system 115 receives payment for the asset file and/or displays an advertisement to the user. In various embodiments, if an advertisement (such as the advertisement that is excerpted in FIGS. 4-6) is played at Step 146, the media file is provided to the user at no charge. Similarly, in particular embodiments, if a user pays for the media file at Step 146, no advertisement (or a revised advertisement) is displayed to the user.

In various embodiments, if a payment is made at Step 146, the above-referenced payment process is facilitated by a payment server 180 that is adapted to provide a payment gateway such as PayPal, authorize.net, Javien, or any other suitable payment gateway. Also, in particular embodiments, if an advertisement is played at Step 146, the advertisement is streamed (or alternatively downloaded) to the user device 127 by an advertisement server 185 that is adapted to implement an ad serving service such as double click, AlmondNet, Tacoda, or any other suitable ad serving service.

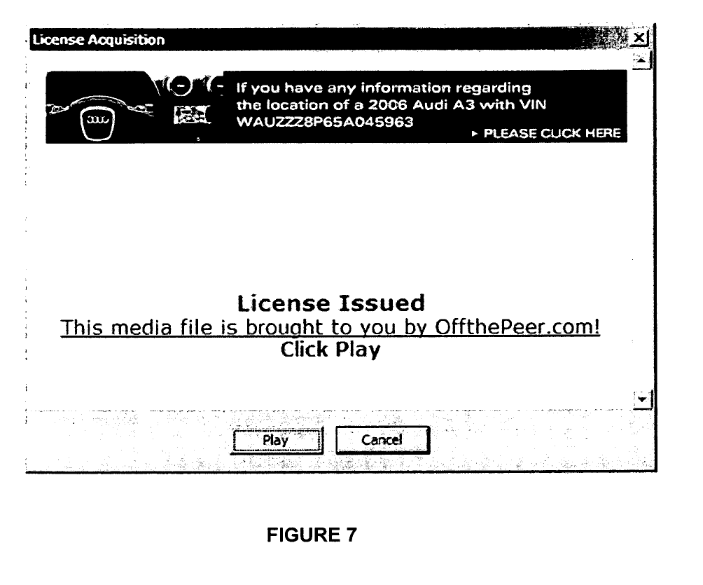

After the system executes Step 146, at steps (8) and (9), respectively, the user's media player requests and receives a license from the licensing server 144, and a licensing acquisition screen (such as the screen shown in FIG. 7) may be displayed to the user. In various embodiments, the license received from the licensing server 144 may be used to play the asset file.

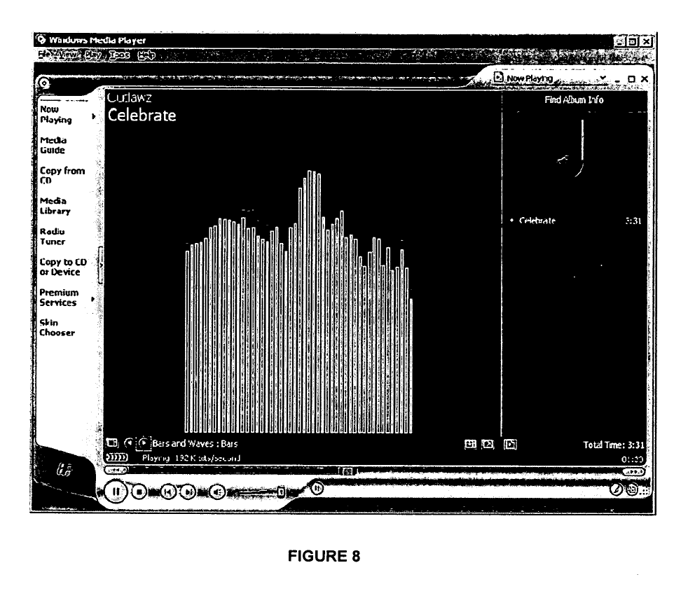

Next, the user's media player proceeds to Step 132 where it validates the license. The user device 127 then saves the license to memory at Step 134, and plays the media file at Step 136 (e.g., either automatically or in response to a user selecting a playback option associated with the user's media player 126). The user 140 then views and/or hears (or otherwise accesses) the content of the media file as it is played by the media player (See FIG. 8).

Asset Database

As may be understood from FIG. 1, in various embodiments of the invention, the media distribution coordination system 115 comprises an asset database 150 that is adapted to act as a repository for various types of data acquired by the media distribution system 10. For example, in various embodiments, when an artist or other content owner 102 submits an asset 104 for distribution via the media distribution system 10, the content owner 102 completes an on-line asset submittal form, which is received by the media distribution coordination system 115 at Step 158. Information from this form (e.g., asset metadata for the asset 104) is then imported into the asset database 150 at Step 160.

In various embodiments, the asset database 150 is also configured to store information from the system's advertising server 185. In particular embodiments, the advertising server 185 is configured to track and store information regarding advertising activity facilitated by the advertising server 185. This information may include, for example: (1) the number and type of advertisements that the payment server provided (e.g., streamed or downloaded) to users over a particular period of time; (2) the dates and times at which these advertisements were displayed to users; and (3) the asset files that the advertisements were associated with when they were provided to users. For example, the payment server may store information indicating: (1) that a first advertisement was streamed to users 20 times during a particular 24 hour period, and that a second advertisement was streamed to users 15 times during that same particular 24 hour period; (2) the particular dates and times that each of these advertisements were streamed to users over the 24 hour period; (3) that each time the first advertisement was streamed during the 24 hour period, it was associated with a particular song by the band Outlawz (e.g., it was streamed to a user as a condition for the user obtaining a download, such as a free download, of the particular Outlawz song); (4) that 10 of the 15 times the second advertisement was streamed during the 24 hour period, it was associated with a particular song by Tupac Shakur; and (5) that 5 of the 15 times the second advertisement was streamed during the 24 hour period, it was associated with a particular song by Dr. Dre. As may be understood from FIG. 1, this information may be periodically imported into the asset database 150 for later use by the media distribution coordination system 115.

Similarly, in various embodiments of the invention, the media distribution coordination system 115 may periodically import various web statistics from a web log 166 into the asset database 150. This information may include, for example, the number of times that one or more particular web pages (e.g., an “approval script/DRM window page”) were viewed, and how many unique visitors to the web pages that represents.

In addition to the information listed above, the asset database 150 may receive, and act as a repository for: (1) asset metadata received from the media distribution system's encoder; (2) license information received from the system's licensing server 144; and (3) asset file sales information from one or more POS distributor servers 122.

Exemplary Implementations of the Media Distribution System

It should be understood that the system architecture described above may provide a flexible system for delivering digital content (e.g., asset files) to users, and for delivering (e.g., dynamically delivering) advertising content to users in association with their receipt or use of the digital content. For example, in various embodiments of the invention, the media distribution system 10 is configured to present an advertisement to a user (e.g., by streaming or downloading the advertisement to the user's electronic device 127) at least partially in response to receiving a request from the user to download a particular asset file.

In various embodiments of the invention, the media distribution system 10 (e.g., the advertising server 185) is adapted to dynamically determine (e.g., in real time) which of a plurality of advertisements to present to a user in response to a request by the user for a particular asset file. In various embodiments, the media distribution system 10 may make this determination based, at least in part, on the date and/or time that the user made (and/or the media distribution system 10 received) the user's request for the particular asset file. This customized advertisement distribution logic may, for example, be customized for one or more particular asset files, or for predetermined groups of asset files. For example, in various embodiments, the system may be adapted for: (1) in response to receiving a request from a user for a first particular file during a first period of time, streaming a first advertisement to an electronic device associated with the user in conjunction with a download of the first particular file to the electronic device; (2) in response to receiving a request from the user for the first particular file during a second period of time, streaming a second advertisement to the electronic device in conjunction with a download of the first particular file to the electronic device; (3) in response to receiving a request from the user for a second particular file during the first period of time, streaming a third advertisement to the electronic device in conjunction with a download of the second particular file to the electronic device; and (4) in response to receiving a request from the user for the second particular file during the second period of time, streaming a fourth advertisement to the electronic device in conjunction with a download of the second particular file to the electronic device.

Also, in particular embodiments, the media distribution system 10 is adapted to determine which of a plurality of advertisements to display to a user based at least in part, on the source of the file request (e.g., based, at least in part, on the particular web site from which the user issued their request for a particular file). Like the time/date based logic described above, this customized advertisement distribution logic may be customized for one or more particular asset files, or for predetermined groups of asset files. For example, in various embodiments, the system may be adapted for: (1) in response to receiving a request from a user, via a first distribution source, for a first particular asset file, streaming a first advertisement to an electronic device associated with the user in conjunction with a download of the first particular asset file to the electronic device; (2) in response to receiving a request from the user, via a second distribution source, for the first particular file, streaming a second advertisement to the electronic device in conjunction with a download of the first particular file to the electronic device; (3) in response to receiving a request from the user, via the first distribution source, for a second particular file, streaming a third advertisement to the electronic device in conjunction with a download of the second particular file to the electronic device; and (4) in response to receiving a request from the user, via the second distribution source, for the second particular file, streaming a fourth advertisement to the electronic device in conjunction with a download of the second particular file to the electronic device.

In various embodiments, the system is configured to base its determination as to which of a plurality of advertisements to display to a user on both: (1) the time that the user requests the asset file, and (2) the source of the request. Like the customized advertisement distribution logic described above, this customized advertisement distribution logic may be customized for one or more particular asset files, or for predetermined groups of asset files. For example, in various embodiments, the system may be adapted for: (1) in response to receiving a request from a user, made via a first distribution source during a first time period, for a first particular file, streaming a first advertisement to an electronic device associated with the user in conjunction with a download of the first particular file to the electronic device; (2) in response to receiving a request from the user, made via a second distribution source during the first time period, for the first particular file, streaming a second advertisement to the electronic device in conjunction with a download of the first particular file to the electronic device; (3) in response to receiving a request from the user, made via the first distribution source during a second time period, for the first particular file, streaming a third advertisement to the electronic device in conjunction with a download of the first particular file to the electronic device; and (4) in response to receiving a request from the user, made via the second distribution source during the second time period, for the first particular file, streaming a fourth advertisement to the electronic device in conjunction with a download of the first particular file to the electronic device.

The media distribution system 10 may take other factors into account when determining which of a plurality of advertisements to display (e.g., stream or download) to a particular user device 127. Such factors may include, for example, transaction history information associated with the particular user, information regarding the user's past behavior (e.g., purchasing behavior), and the technical capabilities and/or constraints of the user device 127.

Also, in various embodiments of the invention, the system may be configured to implement other customized rules regarding the playback of advertisements. For example, the system may be configured to play an advertisement only upon the first playback of a particular asset file by the user; upon each playback of the asset file by the user; or upon every other playback of the asset file by the user. In addition, in certain embodiments, the system may be configured to stream the same or different advertisements to the user upon different playbacks of the asset file by a particular user. For example, the system may be configured to stream: (1) a first advertisement to a user upon a first playback of the asset file; (2) a second advertisement to the user upon the second playback of the asset file; and (3) a third advertisement to the user upon the third playback of the asset file. In various embodiments, the particular advertisements to be streamed to the user may be dynamically determined (e.g., in real time) by the system based on, for example, the date and time that the asset file is played.

In various embodiments, the advertisement server 185 is adapted to allow users (such as content owners and/or advertisers) to modify the system's customized advertisement distribution logic in real time, (or substantially in real time) so that the changes will be implemented immediately or substantially immediately after the advertisement distribution logic has been modified.

In particular embodiments, a set of customized business rules (e.g., in the form of computer-executable instructions for facilitating the execution of the business rules) may be attached to (or otherwise associated with) a particular asset file. This may, for example, allow any of a plurality of systems used to play back the asset file to play back the file according to the particular business rules associated with the asset files. These business rules may define, for example: (1) whether one or more advertisements should be played in conjunction with (e.g., played back before or after) the playback of a particular asset file; and (2) which advertisement or advertisements should be played in conjunction with the playback of the particular asset file. In various embodiments, the business rules may be set up to base the decision as to which of one or more advertisements should be played in conjunction with the playback of a particular asset file on the time at which playback of the asset file is requested, or various other factors. Similarly, these business rules may be set up to use these same types of factors in determining whether one or more advertisements should be played in conjunction with the playback of a particular asset file.

In particular embodiments, the business rules attached to the file may be used to facilitate the playback of advertisements and/or asset files as described in the various examples described elsewhere in this application. For example, the business rules may be used to specify that: (1) a first advertisement should be streamed to a user upon a first playback of a particular asset file; (2) a second advertisement should be streamed to the user upon the second playback of the asset file; and (3) a third advertisement should be streamed to the user upon the third playback of the asset file. As another example, the business rules may be used to specify: (1) that if the asset file is played back during a first time period, a first advertisement should be streamed to the user upon playback of the file during this first time period; and (2) that if the asset file is played back during a second time period, a second advertisement should be streamed to the user upon playback of the file during this second time period.

In particular embodiments, DRM technology may be used to associate (e.g., attach) various sets of business rules (such as those discussed above) to one or more particular asset files. However, it should be understood that any other suitable technology may be used for this purpose.

Accounting Functionality

In various embodiments of the invention, the media distribution system 10 is adapted to facilitate payment to the various owners of assets (e.g., media files) that are distributed via the media distribution system 10. In particular embodiments, the system may be configured to base the amount of such payments at least partially on, for example, the number of times that the asset was downloaded for playback. This payment functionality may be facilitated in any appropriate manner using, for example, information obtained from the system's asset database 150.

In addition, in particular embodiments of the invention, the media distribution system 10 is adapted to bill advertisers based on, for example, the number times that the media distribution system 10 streams particular advertisements to customers. For example, the media distribution system may 10 charge an advertiser $0.01 for each time that one of the advertiser's commercials is streamed to a user device.

Reporting Feature

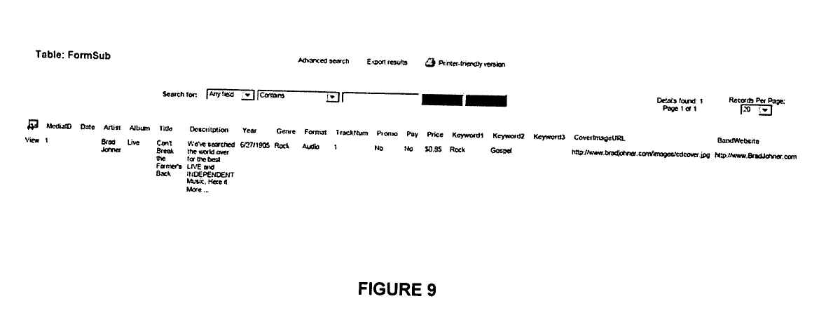

In various embodiments of the invention, the media distribution system may be configured to generate various types of reports (e.g., online and/or paper reports) for reporting any of the information referenced above. In particular embodiments, some or all of this information is retrieved from the media distribution system's asset database 150. Such reports may include, for example: (1) the title of an asset; (2) an artist associated with the asset; (3) the genre of the asset; (4) the current price associated with downloading a copy of the asset file; and/or (5) real-time information regarding how many times the asset has been downloaded from the media distribution system 10 during a particular time period. Such reports may also include, for example, real-time information regarding how many times a particular advertisement has been streamed to a user device during a particular time period. An example of an on-line report generated by one embodiment of the media distribution system 10 is shown in FIG. 9.

Conclusion

Many modifications and other embodiments of the invention will come to mind to one skilled in the art to which this invention pertains having the benefit of the teachings presented in the foregoing descriptions and the associated drawings. For example, while many embodiments of the invention were described above as implementing “streaming” technology to display a particular advertisement to a user, it should be understood that any other appropriate technique of displaying an advertisement may be used in place of streaming. Similarly, while various embodiments of the invention discussed above were described in regard to the distribution of media files, it should be understood that the above techniques may be used to facilitate the distribution of other types of files. In addition, it should be understood that a user's “request for an asset file” may refer, for example, to a request to download or play a particular asset file, such as a music or video file.

Accordingly, it is to be understood that the invention is not to be limited to the specific embodiments disclosed and that modifications and other embodiments are intended to be included within the scope of the appended concepts. Although specific terms are employed herein, they are used in a generic and descriptive sense only and not for the purposes of limitation.

What is claimed is:

1. A media distribution computer system, wherein:
said computer system is adapted for:
(A) in response to receiving a request from a user for a first particular file during a first period of time, facilitating the communication of a first advertisement to said user, via an electronic device associated with said user, in conjunction with a transfer of said first particular file to said electronic device;
(B) in response to receiving a request from said user for said first particular file during a second period of time, facilitating the communication of a second advertisement to said user, via said electronic device, in conjunction with a transfer of said first particular file to said electronic device;
(C) in response to receiving a request from said user for a second particular file during said first period of time, facilitating the communication of a third advertisement to said user, via said electronic device, in conjunction with a transfer of said second particular file to said electronic device; and
(D) in response to receiving a request from said user for said second particular file during said second period of time, facilitating the communication of a fourth advertisement to said user, via said electronic device, in conjunction with a transfer of said second particular file to said electronic device.

2. The media distribution computer system of claim 1, wherein said first and second particular files are video files.

3. The media distribution computer system of claim 1, wherein said first and second particular files are audio files.

4. The media distribution computer system of claim 1, wherein said first, second, third and fourth advertisements are video advertisements.

5. The media distribution computer system of claim 4, wherein said first and second particular files are video files.

6. The media distribution computer system of claim 1, wherein:
(A) said step of facilitating the communication of said first advertisement to said electronic device comprises streaming said first advertisement to said electronic device;
(B) said step of facilitating the communication of said second advertisement to said electronic device comprises streaming said second advertisement to said electronic device;
(C) said step of facilitating the communication of said third advertisement to said electronic device comprises streaming said third advertisement to said electronic device; and
(D) said step of facilitating the communication of said fourth advertisement to said electronic device comprises streaming said fourth advertisement to said electronic device.

7. The media distribution computer system of claim 6, wherein said first, second, third, and fourth advertisements are video advertisements.

8. The media distribution computer system of claim 6, wherein:
said transfer of said first particular file to said electronic device comprises a download of said first particular file to said electronic device; and
said transfer of said second particular file to said electronic device comprises a download of said second particular file to said electronic device.

9. The media distribution computer system of claim 1, wherein:
said transfer of said first particular file to said electronic device comprises a download of said first particular file to said electronic device; and
said transfer of said second particular file to said electronic device comprises a download of said second particular file to said electronic device.

10. A computer system for facilitating the display of media files, wherein:
said computer system is adapted for:
(A) in response to receiving a request from a user to play a first particular media file during a first period of time, facilitating the communication of a first advertisement to said user via an electronic device associated with said user;
(B) in response to receiving a request from said user to play said first particular file during a second period of time, facilitating the communication of a second advertisement to said user via said electronic device;
(C) in response to receiving a request from a user to play a second particular media file during said first period of time, facilitating the communication of a third advertisement to said user via said electronic device; and
(D) in response to receiving a request from said user to play said second particular file during said second period of time, facilitating the communication of a fourth advertisement to said user via said electronic device.

11. The computer system of claim 10, wherein said computer system is adapted for:
reading a first set of business rules attached to said first media file and executing said Steps (A) and (B) at least partially in response to said first set of business rules; and
reading a second set of business rules attached to said second media file and executing said Steps (C) and (D) at least partially in response to said second set of business rules.

12. A media distribution computer system, wherein:
said computer system is adapted for:
(A) in response to receiving a request from a user, via a first distribution source, for a first particular file, facilitating the communication of a first advertisement to said user, via an electronic device associated with said user, in conjunction with a transfer of said first particular file to said electronic device;
(B) in response to receiving a request from said user, via a second distribution source, for said first particular file, facilitating the communication of a second advertisement to said user, via said electronic device, in conjunction with a transfer of said first particular file to said electronic device;
(C) in response to receiving a request from said user, via said first distribution source, for a second particular file, facilitating the communication of a third advertisement to said user, via said electronic device, in conjunction with a transfer of said second particular file to said electronic device; and
(D) in response to receiving a request from said user, via said second distribution source, for said second particular file, facilitating the communication of a fourth advertisement to said user, via said electronic device, in conjunction with a transfer of said second particular file to said electronic device.

13. The media distribution computer system of claim 12, wherein said first and second particular files are video files.

14. The media distribution computer system of claim 12, wherein said first and second particular files are audio files.

15. The media distribution computer system of claim 12, wherein said first, second, third and fourth advertisements are video advertisements.

16. The media distribution computer system of claim 15, wherein said first and second particular files are video files.

17. The media distribution computer system of claim 12, wherein:
(A) said step of facilitating the communication of said first advertisement to said electronic device comprises streaming said first advertisement to said electronic device;
(B) said step of facilitating the communication of said second advertisement to said electronic device comprises streaming said second advertisement to said electronic device;
(C) said step of facilitating the communication of said third advertisement to said electronic device comprises streaming said third advertisement to said electronic device; and
(D) said step of facilitating the communication of said fourth advertisement to said electronic device comprises streaming said fourth advertisement to said electronic device.

18. The media distribution computer system of claim 17, wherein said first, second, third, and fourth advertisements are video advertisements.

19. The media distribution computer system of claim 18, wherein:
said transfer of said first particular file to said electronic device comprises a download of said first particular file to said electronic device; and
said transfer of said second particular file to said electronic device comprises a download of said second particular file to said electronic device.

20. The media distribution computer system of claim 12, wherein:
said transfer of said first particular file to said electronic device comprises a download of said first particular file to said electronic device; and
said transfer of said second particular file to said electronic device comprises a download of said second particular file to said electronic device.

21. A media distribution computer system, said computer system being adapted for:
(A) in response to receiving a request from a user, made via a first distribution source during a first time period, for a first particular file, facilitating the communication of a first advertisement to said user, via an electronic device associated with said user, in conjunction with a transfer of said first particular file to said electronic device;
(B) in response to receiving a request from said user, made via a second distribution source during said first time period, for said first particular file, facilitating the communication of a second advertisement to said user, via said electronic device, in conjunction with a transfer of said first particular file to said electronic device;
(C) in response to receiving a request from said user, made via said first distribution source during a second time period, for said first particular file, facilitating the communication of a third advertisement to said user, via said electronic device, in conjunction with a transfer of said first particular file to said electronic device; and
(D) in response to receiving a request from said user, made via said second distribution source during said second time period, for said first particular file, facilitating the communication of a fourth advertisement to said user, via said electronic device, in conjunction with a transfer of said first particular file to said electronic device.

22. The media distribution computer system of claim 21, wherein said first, second, third and fourth advertisements are video advertisements.

23. The media distribution computer system of claim 22, wherein said first particular file is a video file.

24. A method of distributing a media file to a user, said method comprising said steps of:
(A) making a media file available to said user for download to a remote device;
(B) receiving a request from said user to download said media file; and
(C) in response to receiving said request, transmitting, to an electronic device associated with said user:
an advertisement,
a copy of said media file, and
file security software that is adapted to modify said user's access to said media file in response to said advertisement being played on said electronic device.

25. The method of claim 24, wherein:
said media file is a video file; and
said advertisement is a video advertisement.

26. The method of Concept 24, wherein said step of making said media file available to said user comprises making said media file available to said user via a peer-to-peer network.

27. The method of Concept 24, wherein said file security software comprises Digital Rights Management Software.

28. The method of Concept 24, wherein said method comprises dynamically serving said advertisement directly to said media file.

29. A method of distributing a media file to a user, said method comprising said steps of:
(A) defining a set of advertisement distribution rules specifying that:
a first particular advertisement will be attached to said media file if said media file is downloaded during a first particular period of time; and
a second particular advertisement will be attached to said media file if said media file is downloaded during a second particular period of time;
(B) making said media file available to said user for download to a remote device;
(C) receiving a request from said user to download said media file;
(D) determining whether said request was received during said first particular period of time; and
(E) in response to determining that said request was received during said first particular period of time, transmitting, to an electronic device associated with said user:
a copy of said first particular advertisement,
a copy of said media file, and
file security software that is adapted to modify said user's access to said media file in response to said first particular advertisement being played on said electronic device;
(F) in response to determining that said request was received during said second particular period of time, transmitting, to an electronic device associated with said user:
a copy of said second particular advertisement,
a copy of said media file; and
file security software that is adapted to modify said user's access to said media file in response to said second particular advertisement being played on said electronic device.

30. The method of claim 24, wherein:
said media file is a video file; and
said first and second advertisements are a video advertisements.
